(19) United States
(12) Patent Application Publication
(10) Pub. No.: US 2016/0012931 A1
(43) Pub. Date: Jan. 14, 2016

(54) Conductive Particle

(71) Applicants: Tyco Electronics Corporation, Berwyn, PA (US); Tyco Electronics AMP GmbH, Bensheim (DE)

(72) Inventors: Jaydip Das, Cupertino, CA (US); Ting Gao, Palo Alto, CA (US); Kavitha Bharadwaj, Fremont, CA (US); Nicola Pugliano, Redwood City, CA (US); Dominique Freckmann, San Francisco, CA (US); Helge Schmidt, Speyer (DE)

(73) Assignees: Tyco Electronics Corporation, Berwyn, CA (US); Tyco Electronics AMP GmbH, Bensheim (DE)

(21) Appl. No.: 14/329,684

(22) Filed: Jul. 11, 2014

(51) Int. Cl. H01B 1/02; H01B 1/22

(52) U.S. Cl. CPC H01B 1/02; H01B 1/023; H01B 1/026; H01B 1/22

(57) ABSTRACT

A conductive particle is disclosed. The conductive particle includes an inner material including a first metal and an outer material surrounding the inner material. The outer material includes a second metal. An intermetallic compound is formed between the inner material and the outer material, the intermetallic compound having features from the inner material and the outer material. The conductive particle has a maximum dimension of less than 200 micrometers and the outer material has an outer material thickness of between 0.2 micrometers and 10 micrometers. The conductive particle is substantially devoid of silver.

### FIELD OF THE INVENTION

The present invention is generally directed to materials and particles for production of components. More particularly, the present invention is directed to conductive particles.

### BACKGROUND OF THE INVENTION

Electrically conductive materials are useful in a variety of components. Silver particle is commonly used as the electrically conductive material for numerous components. Silver can be expensive, can be unavailable, and/or can have other undesirable properties. Alternatives to using silver are frequently introduced. However, such alternatives have not adequately addressed certain needs for certain components.

Copper is another widely used inexpensive conductive material in numerous electrical components and applications. However, copper can oxidize or corrode quickly under certain conditions, thereby degrading electrical responses in such electrical components and applications.

Aluminum particles have been used as the electrically conductive material for components. Aluminum is less expensive and more available than silver. However, aluminum can oxidize to form Al₂O₃, which reduces conductivity and is hard. In components requiring high conductivity, soft conductive materials, and/or low contact force, aluminum can be especially problematic.

A conductive particle that shows one or more improvements in comparison to the prior art would be desirable in the art.

### BRIEF DESCRIPTION OF THE INVENTION

In an embodiment, a conductive particle includes an inner material including copper and an outer material surrounding the inner material, the outer material including tin. The conductive particle has a maximum dimension of less than 200 micrometers. The outer material has an outer material thickness of between 0.2 micrometers and 10 micrometers. The conductive particle is substantially devoid of silver.

In another embodiment, a conductive particle includes an inner material including copper and an outer material surrounding the inner material. The conductive particle has one or both of a powder resistivity that is less than or equal to uncoated copper and an oxidation resistance that is greater than silver coated copper and the conductive particle is substantially devoid of silver.

In another embodiment, a conductive particle includes an inner material including aluminum and an outer material surrounding the inner material. The conductive particle has a maximum dimension of less than 200 micrometers. The conductive particle has a conductivity that is greater than or equal to uncoated aluminum. The conductive particle has an oxidation resistance that is greater than uncoated aluminum. The conductive particle is substantially devoid of silver.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a schematic view of a conductive particle, according to an embodiment of the disclosure.

FIG. 2 is a schematic view of a conductive particle, according to an embodiment of the disclosure.

FIG. 3 is a comparative graphical representation of conductivity/resistivity of an embodiment of the conductive particle of FIG. 1 compared to uncoated copper and silver coated copper, according to the disclosure.

FIG. 4 is a comparative graphical representation of the oxidation/weight gain of heat treated and non-treated embodiments of the conductive particle of FIG. 1 exposed to higher temperatures (250° C.) for various times compared to uncoated copper and silver coated copper, according to the disclosure, where more weight gain is representative of more oxidation of the metal particles, while less weight gain is representative of less oxidation of the metal particles.

FIG. 5 is a comparative graphical representation of oxidation/weight gain of heat treated and non-treated embodiments of the conductive particle of FIG. 1 exposed to a temperature of 250° C. for 2 hours compared to uncoated copper and silver coated copper, according to the disclosure, where less weight gain is representative of more oxidative stability of the coated particles.

FIG. 6 is a comparative graphical representation of electrical powder resistivity of the conductive particles of FIG. 1 and FIG. 2 compared to uncoated copper and uncoated aluminum, according to the disclosure.

FIGS. 7-10 are scanning electron microscope images of a conductive particle having a copper dendrite coated by tin, according to an embodiment of the disclosure.

FIG. 11 is a scanning electron microscope image of a conductive particle having an aluminum particle coated by copper then tin, according to an embodiment of the disclosure.

Wherever possible, the same reference numbers will be used throughout the drawings to represent the same parts.

### DETAILED DESCRIPTION OF THE INVENTION

Provided is a conductive particle. Embodiments of the present disclosure, for example, in comparison to concepts failing to include one or more of the features disclosed herein, include improved aging stability, include improved particle-to-particle contact, include increased tunable properties, include improved responses (for example, mechanical, electrical, and/or thermal), and have combinations of such properties and improvements.

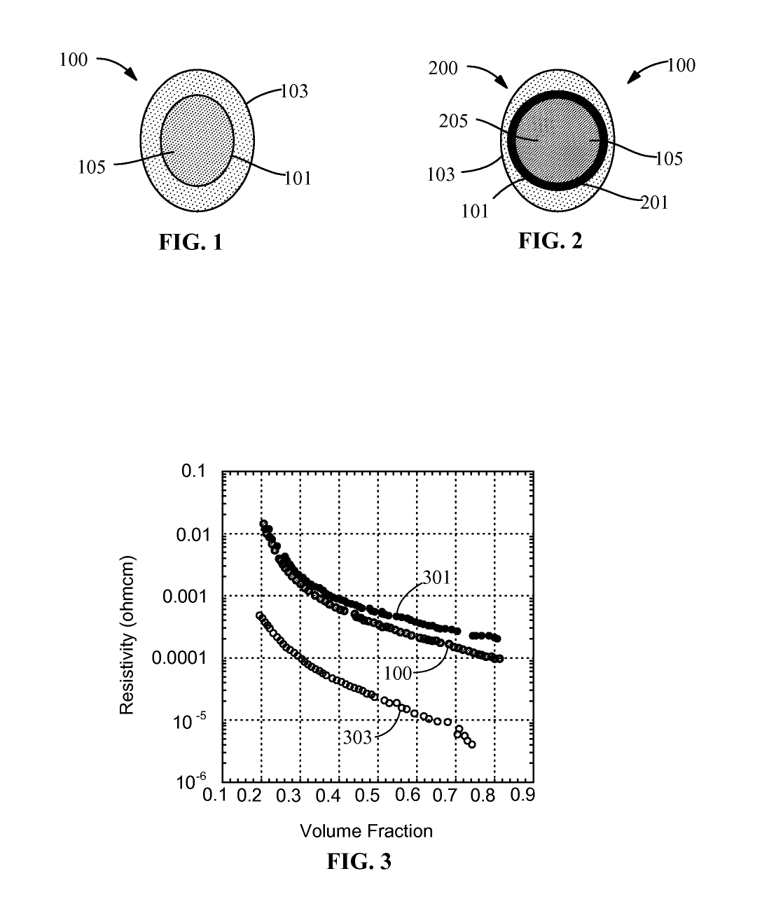

Referring to FIG. 1, a conductive particle 100 includes an inner material 101 and an outer material 103 surrounding the inner material 101. The inner material 101 forms a core region 105 or, as is shown in FIG. 2, in one embodiment, the inner material 101 forms a transition region 201 between the outer material 103 and a core material 205, such as, an aluminum-containing conductive particle 200.

The conductive particle 100 is a finite material having any suitable maximum dimension. Suitable maximum dimensions include, but are not limited to, less than 200 micrometers, less than 150 micrometers, less than 100 micrometers, less than 50 micrometers, less than 10 micrometers, less than 5 micrometers, less than 1 micrometer, between 1 and 200 micrometers, between 1 and 50 micrometers, between 1 and 10 micrometers, between 5 and 10 micrometers, between 5 and 50 micrometers, or any suitable combination, sub-combination, range, or sub-range therein.

The conductive particle 100 is isolated or is positioned in a plurality of the conductive particles 100. In one embodiment, the conductive particle 100 and/or the plurality is molded (for example, injection molded, thermo-molded, sintered, or a combination thereof), extruded, or printed with polymers or used in direct metal laser sintering process (DMLS) process to form a metal-filled composite. In one embodiment, the conductive particle 100 and/or the plurality is mixed with one or more polymer resins and one or more processing aids. In one embodiment, the conductive particle 100 and/or the plurality is mixed with one or more of epoxy and solvent. In a further embodiment, the conductive particles 100 or the plurality or a conductive mixture formed from the particles dispersed in a polymer or epoxy or solvent are treated, such as, by local heat-treating (for example, laser or electron beam sintering techniques). The heat-treating forms intermetallic or alloy compounds at the metal-metal interfaces at suitable thicknesses providing unique intermetallic phases capable of providing increased electrical conductivity and improved stability responses. Suitable inner material thicknesses and/or outer material thicknesses are between 0.2 and 10 micrometers, 0.2 and 5 micrometers, 5 and 10 micrometers, or any suitable combination, sub-combination, range, or sub-range therein. Suitable thicknesses for the intermetallic or alloy compounds are between 0.2 and 5 micrometers, 0.2 and 3 micrometers, 3 and 5 micrometers, or any suitable combination, sub-combination, range, or sub-range therein.

The conductive particle 100 and/or the plurality have several applications. In one embodiment, the conductive particle 100 and/or the plurality is utilized in inks, for example, for printing purposes. In some embodiments, the conductive particles 100 are included within an antenna, automotive component, a data communication component, a sub-sea component, a circuit protection device, or a combination thereof.

Referring to FIG. 3, in one embodiment, the conductive particle 100 has a powder resistivity that is less than or equal to the powder resistivity of uncoated copper 301 (and, thus, a conductivity that is greater than or equal to) and/or greater than the powder resistivity of silver coated copper 303 (and, thus, a conductivity that is less than). The powder resistivity measurement system consists of a pallet press pin-and-die sample holder, a power supply, and two multimeters for outputting DC voltage and current, a hydraulic Carver press, and a computer for simultaneous measurement of applied force, voltage, current, and displacement data. The sample holder is made of two freely moving 1.9 cm diameter copper alloy pins inserted into an electrically insulated mold that receive a linear force from 100 to 10000 pounds in a stepped fashion, whereby each step is a simultaneous measurement of applied force, current, and pin displacement. The measured powder resistivity is a function of the powder volume fraction and the volume fraction is the ratio of the powder packing density to the bulk material density as determined by helium pyenometry.

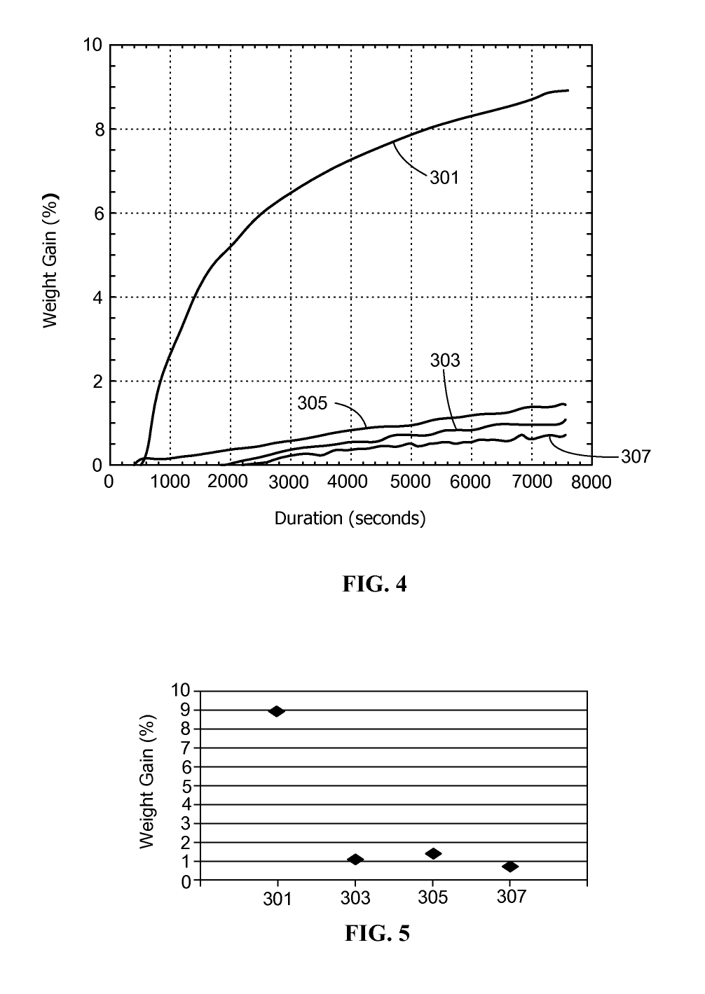

Referring to FIG. 4, in one embodiment, the conductive particle 100 has an oxidation resistance (as shown by percentage of weight gain) as a function of time at 250° C. in air. In one embodiment, the oxidation resistance is greater than the oxidation resistance of uncoated copper 301, for example, with the conductive particle 100 being a non-treated conductive particle 305 or a heat-treated conductive particle 307. In one embodiment, the oxidation resistance is greater than silver coated copper 303, for example, with the conductive particle 100 being the heat-treated conductive particle 307. The heat-treated conductive particle 307 is formed by heat treatment, for example, at a temperature of 150° C. or greater, for a period of time (such as, at least 5 minutes), and/or substantially in a vacuum or other inert atmosphere (such as, nitrogen or argon) or in air.

Referring to FIG. 5, in one embodiment, the conductive particle 100 has an oxidation resistance (as shown by percentage of weight gain) as a function of time at 250° C. for 2 hours in air. In one embodiment, the oxidation resistance is greater than the oxidation resistance of uncoated copper 301, for example, with the conductive particle 100 being a non-treated conductive particle 305 or a heat-treated conductive particle 307. In one embodiment, the oxidation resistance is greater than silver coated copper 303, for example, with the conductive particle 100 being the heat-treated conductive particle 307. The heat-treated conductive particle 307 is formed by heat treatment, for example, at a temperature of 150° C. or greater, for a period of time (such as, at least 5 minutes), and/or substantially in a vacuum or other inert atmosphere (such as, nitrogen or argon) or in air.

The conductive particle 100 includes any suitable materials and is formed by any suitable process. The conductive particle 100 is substantially devoid of silver and/or includes a plurality of materials providing desired properties.

The inner material 101 of the conductive particle 100 is or includes a metal or a non-metal. In one embodiment, the inner material 101 includes a metal selected from the group consisting of copper, aluminum, nickel, and combinations thereof. The metal is in any suitable form, such as a dendrite, flake, fiber, wool, and/or sphere. In one embodiment, the inner material 101 includes a non-metal material selected from the group consisting of carbon, glass, polymer, alumina, and combinations thereof.

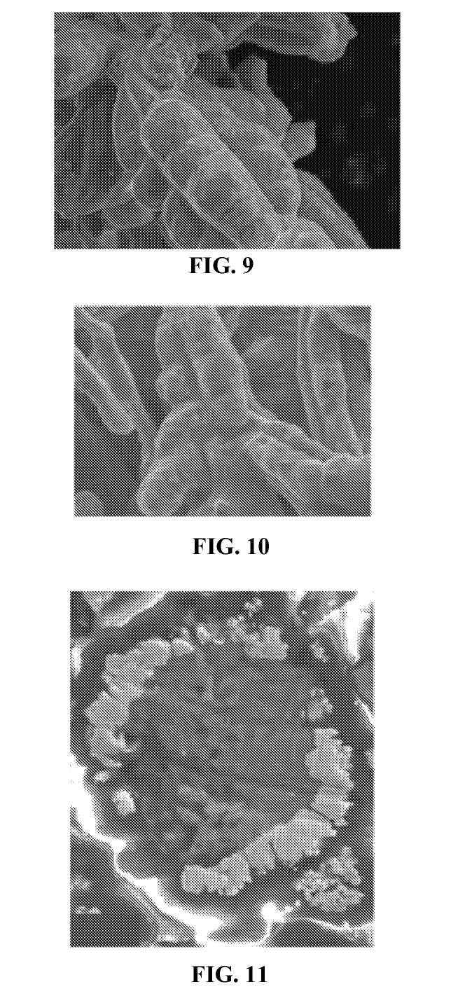

The outer material 103 of the conductive particle 100 is or includes tin or another material capable of producing the properties of the conductive particle 100. The outer material 103 directly or indirectly surrounds and/or encloses the inner material 101. In one embodiment, the outer material 103 is bonded to the inner material 101. In one embodiment, the outer material 103 and the inner material 101 form an alloy within the conductive particle 100. In one embodiment, the outer material 103 and the inner material 101 form an intermetallic compound and/or zone, for example, having features from the outer material 103 and the inner material 101. As shown in FIGS. 7-10, in one embodiment, the inner material 101 includes a copper dendrite and is coated by the outer material 103, which includes tin. In another embodiment, as shown in FIG. 11, the inner material 101 includes an aluminum particle and is coated by the outer material 103, which includes tin. As will be appreciated, the inner material 101, the outer material 103, the core material 205, the core region 105, the transition region 201, layers between any such materials or regions, layers surrounded by any such materials or regions, and/or layers surrounding any such materials or regions are capable of including transitional features, such as, intermetallic alloys, diffuse materials, gradient compositions, or discrete compositional regions.

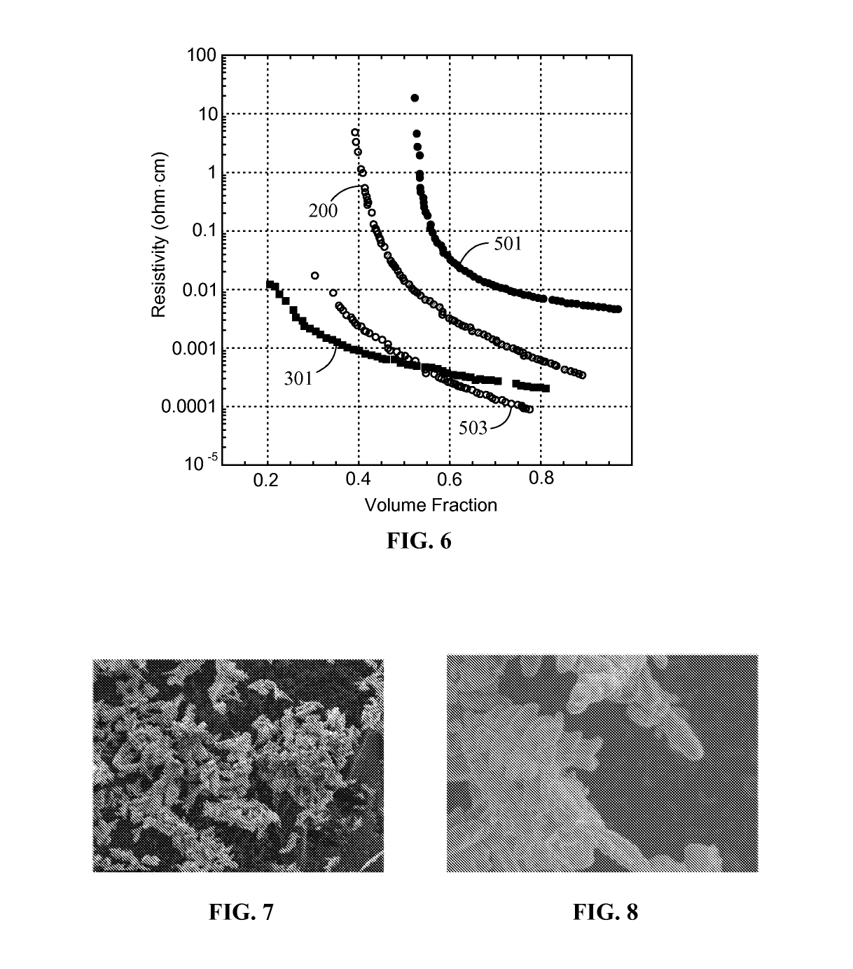

Referring to FIG. 2, in one embodiment, the conductive particle 100 includes the core region 105 having the core material 205 and being surrounded/enclosed by the transition region 201 (for example, the inner material 101), which is further surrounded/enclosed by the outer material 103, for example, the aluminum-containing conductive particle 200. The core material 205 is any suitable inorganic and/or metal material. In one embodiment, the core material 205 is or includes aluminum, copper, and/or nickel. Referring to FIG. 6, in one embodiment, the aluminum-containing conductive particle 200 includes powder resistivity that is less than uncoated aluminum 501 and/or greater than uncoated copper 301 and/or greater than or equal to copper-coated aluminum 503.

In one embodiment, the conductive particle 100 is formed by pre-treating the inner material 101 to remove organic contaminates and/or oxide layers. The pre-treating is followed by depositing the outer material 103. In one embodiment, the conductive particle 100, for example, the aluminum-containing conductive particle 200, is formed by cleaning and sensitizing one or more aluminum particles, prior to coating with the inner material 101 and the outer material 103. The cleaned and sensitized particles are immersed in a solution corresponding with the inner material 101, for example, additives (such as, stress reducers and fluoride ions). The particles are rinsed and filtered after being immersed in the solution. The particles are then coated with a solution corresponding with the outer material 103.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A conductive particle, comprising:
an inner material including a first metal; and
an outer material surrounding the inner material, the outer material including a second metal;
an intermetallic compound formed between the inner material and the outer material, the intermetallic compound having features from the inner material and the outer material;
wherein the conductive particle has a maximum dimension of less than 200 micrometers;
wherein the outer material has an outer material thickness of between 0.2 micrometers and 10 micrometers;
wherein the conductive particle is substantially devoid of silver.

2. The conductive particle of claim 1, further comprising a third metal surrounded by the inner material.

3. The conductive particle of claim 1, wherein the first metal comprises copper.

4. The conductive particle of claim 1, wherein the first metal comprises aluminum.

5. The conductive particle of claim 1, wherein the second metal comprises tin.

6. The conductive particle of claim 1, wherein the second metal comprises copper.

7. The conductive particle of claim 1, wherein the outer material consists of cobalt or nickel.

8. The conductive particle of claim 1, wherein the intermetallic compound has an intermetallic thickness of between 0.2 micrometers and 5 micrometers.

9. The conductive particle of claim 1, wherein the conductive particle is heat-treated at a temperature of at least 150° C. for at least 5 minutes.

10. The conductive particle of claim 1, wherein the conductive particle is not heat-treated.

11. The conductive particle of claim 1, wherein the inner material surrounds a core region and has an inner material thickness of between 0.2 micrometers and 10 micrometers.

12. The conductive particle of claim 1, wherein the inner material is a core region of the conductive particle.

13. The conductive particle of claim 1, wherein the first metal comprises copper dendrite, copper sphere, copper flake, copper fiber, or copper powder.

14. The conductive particle of claim 1, further comprising one or more layers surrounding the outer material.

15. A conductive composite formulation comprising a plurality of conductive particles of claim 1, molded or extruded with one or more polymers, and one or more processing aids.

16. A conductive composite formulation comprising a plurality of conductive particles of claim 1, mixed with one or more of epoxy and solvent.

17. A conductive particle, comprising:
an inner material including copper; and
an outer material surrounding the inner material;
wherein the conductive particle has one or both of a powder resistivity that is less than or equal to uncoated copper and an oxidation resistance that is greater than silver coated copper;
wherein the conductive particle is substantially devoid of silver.

18. A conductive particle, comprising:
an inner material including aluminum; and
an outer material surrounding the inner material;
wherein the conductive particle has a maximum dimension of less than 200 micrometers;
wherein the conductive particle has a powder resistivity that is less than or equal to uncoated aluminum; and
wherein the conductive particle has an oxidation resistance that is greater than uncoated aluminum;
wherein the conductive particle is substantially devoid of silver.
